(19) United States
(12) Patent Application Publication
(10) Pub. No.: US 2022/0023145 A1
(43) Pub. Date: Jan. 27, 2022

(54) Myofascial and trigger point therapy ball pouch- TPT pak

(71) Applicant: MyTrang Donahue, Royal Palm Beach, FL (US)

(72) Inventor: MyTrang Donahue, Royal Palm Beach, FL (US)

(21) Appl. No.: 16/939,005

(22) Filed: Jul. 26, 2020

(51) Int. Cl. A61H 39/04; A61H 15/00

(52) U.S. Cl. CPC A61H 39/04; A61H 15/00; A61H 2201/0157; A61H 2201/1654; A61H 2201/165; A61H 2015/0064

(57) ABSTRACT

The invention relates to a pouch with divided pockets to insert any single or multiple balls ranging in sizes similar to a standard size golf ball and/or tennis ball to stabilize the ball(s) at the desire position of the user to relieve muscle pain, tightness, and knots in the treatment of myofascial trigger point therapy. Trigger points or muscle ‘knots’ are sensitive spots in soft tissue, and too many of them is “myofascial pain syndrome.” Common areas of muscle knots are located in the neck, back, shoulders, sciatica, and in the arch of a foot. Trigger point therapy is typically used as muscle releaser by applying pressure directly onto the trigger point for a given amount of time that is suggested by a medical professional. The pouch that holds the ball(s) is used to trigger the knots by placing a standard size tennis ball or for a deeper tissue therapy, a golf ball, inside the desired pocket(s) to stabilize the ball from rolling away during treatment. The user may treat more than one area at a time by placing more balls in any pocket(s). Once the user places the balls inside the pocket(s), the balls are secured by a closure on one side of the pouch. The user may use the adjustable strap with fastener as a handle or latch it for a handsfree treatment. The strap may also be used for added compression and as a convenient carrying element.

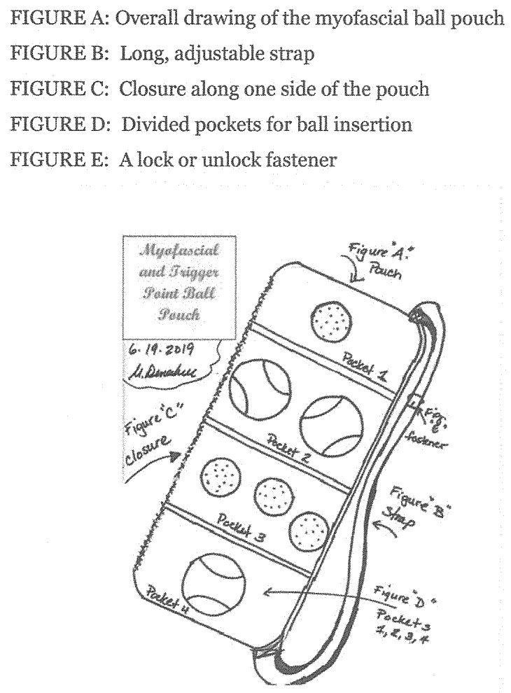

### BACKGROUND OF THE INVENTION

Trigger point therapy is a bodywork technique that involves the application of pressure to tender muscle tissue in order to relieve pain and dysfunction in other parts of the body. It may also be called myofascial (myo meaning muscle, fascial meaning connective tissue) trigger point therapy. Trigger point therapy is sometimes regarded as one of a group of treatment approaches called neuromuscular therapy or NMT.

The trigger point therapy was first developed in the 1940s by Janet Travell, a medical professional from the United States of America. For years, trigger point therapy has been practiced and endorsed by many medical doctors, health professionals, and by the general public including self-help videos and books.

Although trigger point therapy is effective in releasing muscle tightness or knots, there are some inconvenient issues when applying a free-rolling ball whether in a vertical or horizontal position. When placing or rolling a pall on the trigger point whether in a vertical or horizontal position, occasionally, the ball rolls away during treatment. In addition, trying to position the ball with limited mobility to reach behind the body could be a challenge for injured or disabled individuals, therefore a fixed strap provides an extended reach and ease of ability to position the device. The enclosed pouch with divided pockets isolates the ball(s) from rolling or dropping during the treatment. The divided pockets could hold one or more balls depending on the desired pressure of the trigger point therapy. Adding more balls within the pockets provide a lesser pressure on the trigger point. Whereas having less balls deliver a deeper tissue pressure. The pocket offers space to manipulate the ball for trigger point or myofascial massage. The length of the pouch provides the user to target multiple trigger points at the same time. The strap could be carried across the chest or over-the-shoulder. The recommended size and shape of balls that could be used for the myofascial ball pouch is of any that is similar to a standard size and shape of a tennis ball or golf ball.

### SUMMARY OF INVENTION

The invention is a pouch with multiple divided enclosed pockets with a fastened strap designed to hold standard size tennis balls and golf balls or other balls similar to size and shape for the purpose of stabilizing and isolating the balls for trigger point therapy. The pouch provides a user to isolate the ball within its secured pocket without rolling or dropping from its intended position during a myofascial treatment. The adjustable strap supports additional range of motion for the user to manipulate the pouch and ball onto the desired trigger point(s), which is ideal for individuals with limited mobility. The fastener, when latched could be applied to as a gentle compression or strapped across the chest for a handsfree treatment. On one side of the pouch is a closure to secure the balls in its pocket(s). The multiple pockets give the user control of how many trigger points and the level of pressure are during a myofascial therapy.

1. Trigger point therapy is a bodywork technique that involves the application of pressure to tender muscle tissue in order to relieve pain and dysfunction in other parts of the body. It may also be called myofascial (myo meaning muscle, fascial meaning connective tissue) trigger point therapy. Trigger point therapy is sometimes regarded as one of a group of treatment approaches called neuromuscular therapy or NMT. We claim that having an enclosed pouch with divided pocket(s) to hold one or more balls with similar size, shape, and firmness of a standard size tennis ball and/or golf ball would stabilize the ball(s) from rolling away during a myofascial or trigger point therapy session. The attached strap with fastener has multiple purposes. The strap could be used as an extension for any patient or user with or without full range of motion to reach and adjust the position of the ball with ease for an accurate positioning of a trigger point. The fastener could be latched and adjusted for a snug fit, acting as a gentle compression and handsfree therapy when used while standing upward. The individual pockets offer a user to treat more than one trigger point at a time. Each pocket has enough space to insert extra balls for a less intense pressure therapy or apply only one ball and use the added space to move the ball around inside the secured pocket to massage the myofascial point. The strap may also serve as a convenient carrying element.
